(19) United States
(12) Patent Application Publication
(10) Pub. No.: US 2009/0037343 A1
(43) Pub. Date: Feb. 5, 2009

(54) INCUBATOR INVESTMENT STRUCTURE

(76) Inventors: Jeff LANDLE, New York, NY (US); Alexander SCHWEICKHARDT, Vienna (AT)

Correspondence Address: OSTROLENK FABER GERB & SOFFEN, 1180 AVENUE OF THE AMERICAS, NEW YORK, NY, 100368403, US

(21) Appl. No.: 11/833,405

(22) Filed: Aug. 3, 2007

(51) Int. Cl. G06Q 40/00

(52) U.S. Cl. 705/36 R

(57) ABSTRACT

An incubator investment structure including at least one incubated fund, an incubator participation fund investing in the incubated fund, and investors investing in the incubator participation fund. The incubated fund includes assets other than investments from the incubator participation fund. The incubated fund charges a management fee and/or a performance fee to its investors. However, it returns a portion of the fee it charges to the other assets to the incubator participation fund. Moreover, it gives a discount on the fees charged to the incubator participation fund. The incubator participation fund, in turn, passes a fraction of this returned portion of the other assets fee and the discount on to its investors.

### BACKGROUND

The invention relates to the field of managing and product structuring of collective investment pools commonly referred to as “hedge funds.”

A hedge fund is generally defined as a pool of private capital used to leverage an investment portfolio structured as a domestic limited partnership or an offshore corporation. A general partner and/or investment manager is expected to have sophisticated portfolio management practices; investors are generally high net-worth individuals and institutions. Hedge funds often have restricted liquidity since they cannot be traded in the open market. Moreover, hedge funds are not required to report their assets or returns to the U.S. Securities & Exchange Commission (SEC) or to any other entity whose information is made available to the public. Additionally, hedge fund advertising is generally restricted. Thus, unless a hedge fund voluntarily reports its existence and performance to some database, the public may be unable to learn of either.

In recent years the term “hedge fund” has been used broadly to refer to any type of alternative investment strategy.

Investors in hedge funds must be knowledgeable and experienced in financial and business matters such that they would be capable of evaluating the merits and risks of the acquisition of securities. Additionally, such investors are typically willing and able to bear economic risks of this investment and even complete loss of their investment.

A typical hedge fund investment structure is shown in FIG. 4. In this investment structure, investors place their investments with a hedge fund, which charges investors a management and/or performance fee and invests its assets in accordance with its investment strategy. In turn, investors receive a return on their investment, which is typically a portion of the return received by the hedge fund.

### BRIEF SUMMARY

In general, in a first aspect, the invention features an incubator investment structure including at least one incubated fund, an incubator participation fund investing in the incubated fund, and investors investing in the incubator participation fund. The incubated fund includes assets other than investments from the incubator participation fund. The incubated fund charges a management fee and/or a performance fee to its investors. However, it returns a portion of the fee it charges to the other assets to the incubator participation fund. Moreover, it gives a discount on the fees charged to the incubator participation fund. The incubator participation fund, in turn, passes a portion of this returned capital on to its investors. The investors receive guaranteed future capacity at fee discount.

In general, in a second aspect, the invention features a method of investing in an incubated fund, comprising the steps of establishing an incubator participation fund having at least one investor; using said established incubator participation fund to invest in said incubated fund; charging a fee by said incubated fund from its investors; using said incubator participation fund to receive a portion of a fee charged by said incubated fund to assets other than investments by said incubator participation fund; using said incubator participation fund to receive a discount from said incubated fund of a fee charged to said investments by said incubator participation fund; and using said incubator participation fund to pass a fraction of said portion of said other assets fee and said discount on to said at least one investor of said incubator participation fund.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a block diagram of an overall company structure accomplishing the incubator investment.

FIG. 2 is a block diagram of an incubator investment structure in accordance with the present invention.

FIG. 3 is a chart showing hypothetical returns of an investor investing into the incubator investment structure of the present invention.

FIG. 4 is a block diagram of a known hedge fund investment structure.

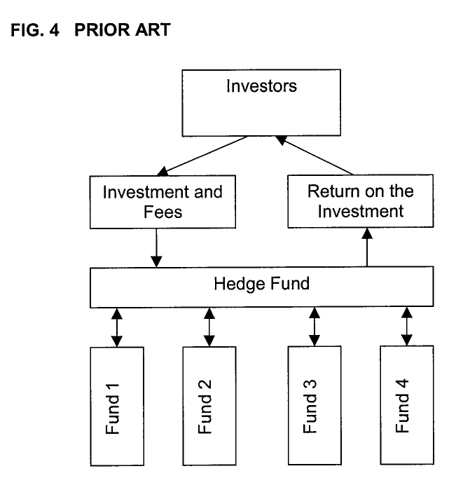

FIG. 5 is a table summarizing the results of the hypothetical investment shown in FIG. 3.

### DESCRIPTION

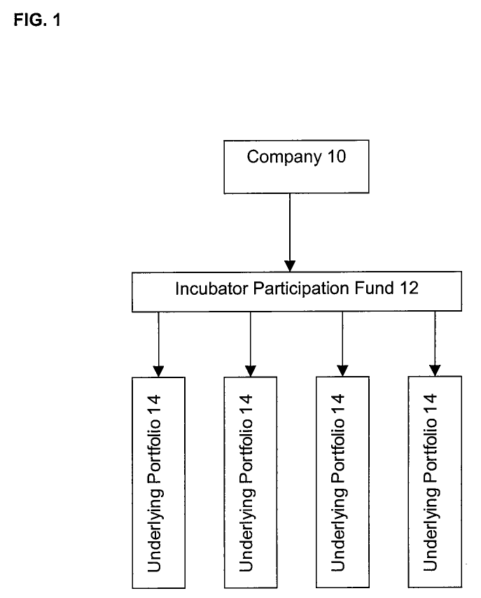

In accordance with the preferred embodiment illustrated in FIG. 1, an open-ended exempt Company 10 (or similar structure) is first formed and is registered as a segregated portfolio company under the laws of any off-shore or domestic jurisdiction, for example, State of Delaware or the Cayman Islands. Company 10 is a segregated portfolio company with segregated portfolios, each of which constitutes a separate segregated portfolio of the company. The board of directors of Company 10 has the power to create segregated portfolios from time to time, and issue different classes of shares with respect to each segregated portfolio. Each segregated portfolio is separately valued and has its own defined investment objectives and strategies.

The board of directors of Company 10 has established an incubator participation fund 12 of Company 10 with its own investment objective and policy. Incubator participation fund 12 offers shares in accordance with its terms and conditions. The investment objective of fund 12 is to obtain capital appreciation as well as annual revenue by making seed investments in underlying portfolios 14. These investments will entitle the fund to reduced management and/or performance fees and may entitle fund 12 to enhanced participations (i.e., amounts that (i) would otherwise have been earned by the portfolio advisors and (ii) represents a return greater than the fund's relative investments in the underlying portfolio). The right to receive reduced fees and enhanced participations and other preferential rights related to seed investments are collectively referred to as “preferential rights.”

Underlying portfolios 14 are private investment funds, managed accounts of derivative instruments linked to the return of private investment vehicles and managed accounts each of which is advised by portfolio advisors. Independent of the portfolio advisors, fund 12 employs an investment advisor having its preferential rights. The investment advisor selects portfolio advisors that demonstrate expertise in their respective market sectors and develops a comprehensive model for analyzing risks and opportunities in each such sector. Underlying portfolios 14 employ strategies developed by the independent advisor including, but not limited to, global macro strategy, futures, physical commodities, securitized and other credit strategies, fixed income and long/short equity strategies. The investment advisor diversifies its investments in the underlying portfolios across a variety of geographic locations and market sectors.

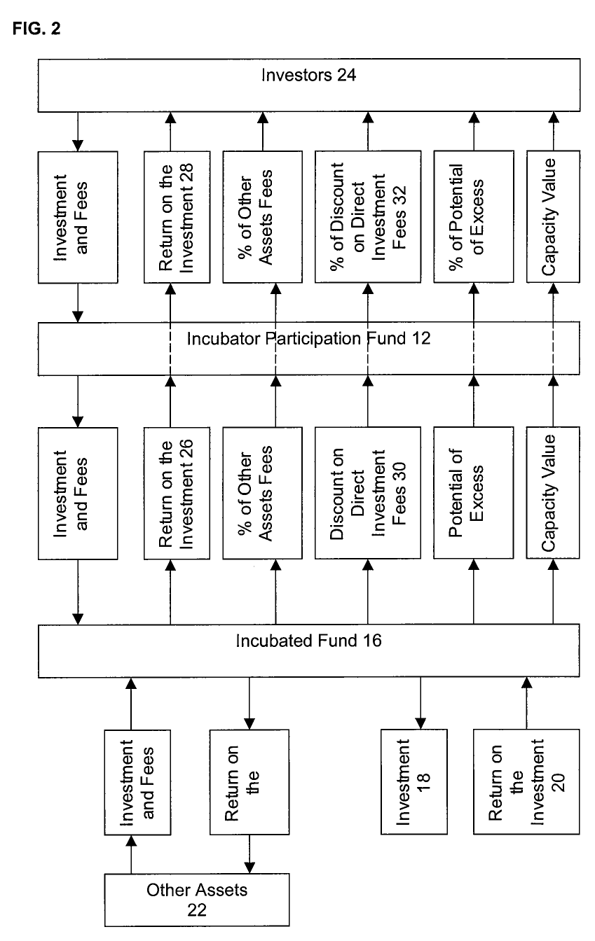

In accordance with the preferred embodiment, incubator participation fund 12 allows investors to participate in the returns of talented early stage managers on a preferred revenue participation basis. As shown in FIG. 2, the investment structure of the present invention allows investors through their investments in the incubator participation fund 12 to share in four additional revenue sources: 1) a revenue share of the performance and/or management fees based on asset growth; 2) discount on performance and management fees on direct investment; 3) participation in the potential of excess returns of early stage managers; and 4) capacity value of securing capacity at attractive rates.

More particularly, as shown in FIG. 2, the incubator investment structure of the preferred embodiment of the present invention includes at least one incubated fund 16 making investments 18 in accordance with its investment strategy. In return for its investment, incubated fund 16 receives its return 20, which it passes on to its investors. Incubator participation fund 12 is one of the investors investing in the incubated fund 16. In addition to the incubator participation fund 12, incubated fund 16 includes assets 22 received from other investment sources. In the embodiment of the present invention shown in FIG. 2, incubator participation fund 12 has its own investors 24. However, it should be understood by a person skilled in the art of investing that incubator participation fund 12 does not need to have investors 24. Instead, fund 12 can invest its own assets in incubated fund 16. Incubator participation fund 12 receives a return on its investment 26 from the incubated fund 16. Investors 24, in their turn, receive a return on their investments 28 from the incubator participation fund 12. The investors' return on the investment 28 includes at least a portion of the incubator participation fund's return on the investment 26.

In accordance with the invention, incubated fund 16 charges a fee to its investors. Typically, this fee includes a performance and/or management fee. All investors, including investors of other assets 22 and the incubator participation fund 12, pay the above fee. Similarly, if the incubator participation fund 12 chooses to have its own investors 24, it charges investors 24 a performance and/or management fee. Incubator participation fund 12 receives a discount 30 on a fee it is charged by the incubated fund 16. Additionally, incubator participation fund 12 receives a portion 34 of a fee charged by the incubated fund 16 to the investors of the other assets 22. Incubator participation fund 12 passes a percentage 36 of the other assets fee portion 34 and a percentage 32 of the discount 30 on to its investors 24. Finally, the incubator participation fund 12 shares with its investors 24 the revenue it receives from participation in the potential of excess returns of early stage managers and from capacity value of securing capacity at attractive rates.

### EXAMPLE

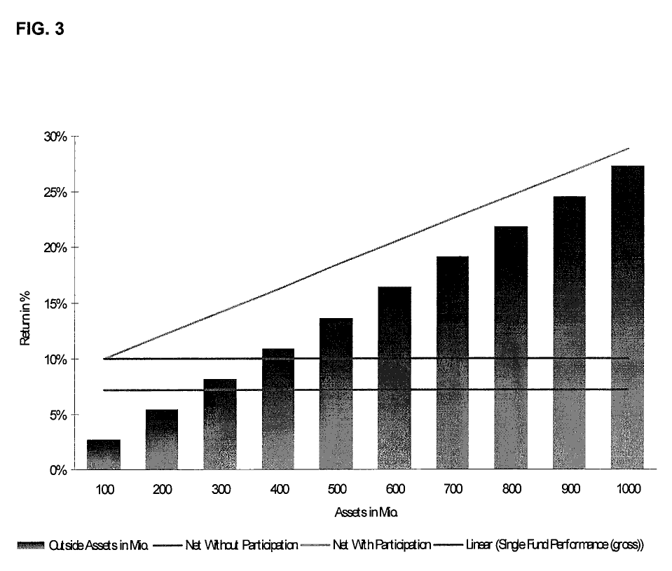

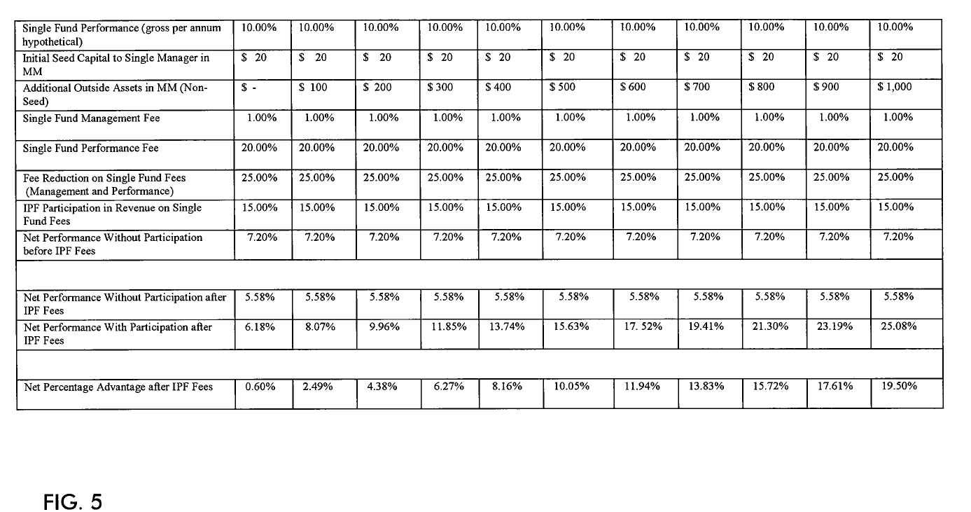

FIG. 3 illustrates the preferred embodiment of the present invention where incubator participation fund 12 invests in a single hypothetical incubated fund 16 having a gross of fee return of 10%, 25% reduction in fees paid by the incubator participation fund 12 and a 15% participation in the incubated fund's fees earned from other assets under management. The hypothetical example also reflects the 1% management fee and 10% performance fee of the incubator participation fund 12, as well as administrative and accounting expenses of the incubator participation fund. The example shown in FIG. 3 illustrates hypothetical returns at different levels of assets under management. Results of the hypothetical investment are summarized in the table shown in FIG. 5.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

The invention claimed is:

1. An incubator investment structure comprising:
at least one incubated fund;
an incubator participation fund investing in said at least one incubated fund; and
at least one investor investing in said incubator participation fund,
wherein said at least one incubated fund charges a fee to its investors; wherein said at least one incubated fund includes assets other than investments from said incubator participation fund; wherein said incubator participation fund receives a portion of a fee charged by said at least one incubated fund to said other assets and a discount on a fee charged by said at least one incubated fund to said incubator participation fund; and wherein said incubator participation fund passes a fraction of said portion of said other assets fee and said discount on to said at least one investor.

2. The incubator investment structure of claim 1, wherein said fee charged by said at least one incubated fund comprises at least one of a management fee and a performance fee.

3. The incubator investment structure of claim 2, wherein said management fee of said at least one incubated fund is 1%.

4. The incubator investment structure of claim 2, wherein said performance fee of said at least one incubated fund is 20%.

5. The incubator investment structure of claim 1, wherein said incubator participation fund receives a revenue from participation in a potential of excess returns of early stage managers and wherein said incubator participation fund shares said revenue from participation with said at least one investor.

6. The incubator investment structure of claim 1, wherein said incubator participation fund receives a revenue from a capacity value of securing an investment capacity at reduced rates and wherein said incubator participation fund shares said revenue from said capacity value with said at least one investor.

7. A method of investing in an incubated fund, comprising the steps of:
establishing an incubator participation fund having at least one investor;
using said established incubator participation fund to invest in said incubated fund; charging a fee by said incubated fund from its investors; using said incubator participation fund to receive a portion of a fee charged by said incubated fund to assets other than investments by said incubator participation fund;
using said incubator participation fund to receive a discount from said incubated fund for a fee charged to said investments by said incubator participation fund; and
using said incubator participation fund to pass a fraction of said portion of said other assets fee and said discount on to said at least one investor of said incubator participation fund.

8. The method of investing in an incubated fund of claim 7, wherein said fee charged by said at least one incubated fund comprises at least a management fee and a performance fee.

9. The method of investing in an incubated fund of claim 7, wherein said management fee of said at least one incubated fund is 1%.

10. The method of investing in an incubated fund of claim 7, wherein said performance fee of said at least one incubated fund is 20%.

11. The method of investing in an incubated fund of claim 7, wherein said incubator participation fund receives a revenue from participation in a potential of excess returns of early stage managers and wherein said incubator participation fund shares said revenue from participation with said at least one investor.

12. The method of investing in an incubated fund of claim 7, wherein said incubator participation fund receives a revenue from a capacity value of securing an investment capacity at reduced rates and wherein said incubator participation fund shares said revenue from said capacity value with said at least one investor.

13. An incubator investment structure comprising:
at least one incubated fund; and
an incubator participation fund investing in said at least one incubated fund,
wherein said at least one incubated fund charges a fee to its investors; wherein said at least one incubated fund includes assets other than investments from said incubator participation fund; and wherein said incubator participation fund receives a portion of a fee charged by said at least one incubated fund to said other assets and a discount on a fee charged by said at least one incubated fund to said incubator participation fund.

14. The incubator investment structure of claim 13, wherein said fee charged by said at least one incubated fund comprises at least a management fee and a performance fee.

15. The incubator investment structure of claim 14, wherein said management fee of said at least one incubated fund is 1%.

16. The incubator investment structure of claim 14, wherein said performance fee of said at least one incubated fund is 20%.

17. The incubator investment structure of claim 13, wherein said incubator participation fund receives a revenue from participation in a potential of excess returns of early stage managers.

18. The incubator investment structure of claim 13, wherein said incubator participation fund receives a revenue from a capacity value of securing an investment capacity at reduced rates.
